(19) United States
(12) Patent Application Publication
(10) Pub. No.: US 2022/0358096 A1
(43) Pub. Date: Nov. 10, 2022

(54) MANAGEMENT OF CONSISTENT INDEXES WITHOUT TRANSACTIONS

(71) Applicant: NUTANIX, INC., San Jose, CA (US)

(72) Inventors: Sandeep MADANALA, Hyderabad (IN); Anoop JAWAHAR, Bangalore (IN); Yasaswi KISHORE, Bangalore (IN); Rituparna SAIKIA, Bangalore (IN); Parmpreet SINGH, Sangrur (IN); Ronak SISODIA, Bijainagar (IN)

(21) Appl. No.: 17/362,749

(22) Filed: Jun. 29, 2021

(30) Foreign Application Priority Data
May 6, 2021 (IN) 202141020710

(51) Int. Cl. G06F 16/182; G06F 16/22

(52) U.S. Cl. CPC G06F 16/182; G06F 16/2272

(57) ABSTRACT

In various embodiments, a computer-implemented method for supporting consistent secondary indexes, comprises receiving, at a first node, a write request comprising a data entry, storing the data entry in an in-memory structure separate from a primary structure for storing the data entry, generating, based on the data entry, a secondary index data entry for a secondary index, and transmitting the secondary index data entry to a second node for inclusion in the secondary index.

### RELATED APPLICATIONS

This patent application claims priority to and the benefit of the filing date of India Provisional Patent Application No. 202141020710, titled “MANAGEMENT OF CONSISTENT INDEXES WITHOUT TRANSACTIONS,” filed on May 6, 2021, which is incorporated by reference herein in its entirety.

### TECHNICAL FIELD

The contemplated embodiments relate generally to management of distributed storage and, more specifically, to management of consistent indexes without transactions.

### BACKGROUND

In various storage systems and databases, a client can access a specific record by using a primary key to query a database. For example, each entry in a database table could have a unique sequence number, where the sequence number is the primary key for the database table. Secondary indexes provide an alternative means for efficiently accessing records in a primary database by using attributes other than the usual primary key. In some examples, a secondary index can include data structures that contain a subset of attributes from a base table, and a secondary key. The smaller secondary index improves the speed and efficiency of query operations used to retrieve data. In order to maintain consistency between values in the base table and the secondary index, the secondary index receives updates based on various actions, such as an application writing, updating, or deleting items in a base table.

In many conventional databases, such updates to each secondary index can occur lazily or asynchronously, using an eventually-consistent model. However, the eventually-consistent model typically results in a propagation delay between updates that are made to the base table and corresponding updates that are made to each secondary index. Such propagation delays can result in inconsistent query results for queries performed using the secondary indexes. For example, a query cannot return results that reflect all the writes successfully acknowledged to the base table.

Some other conventional databases rely on distributed transactions to resolve the issues arising from the eventually-consistent model for secondary indexes. Using distributed transactions mitigates the occurrence of inconsistent query results for queries using secondary indexes by ensuring the base table and the secondary indexes maintain consistency, such as applying transactions to update the secondary index after every update that is made to the base table. However, distributed transactions are difficult to implement, and are expensive to execute in terms of overhead, performance lags, or the like. For example, distributed transactions typically involve multiple complex internal writes for each incoming write request, thereby increasing transaction latency and resulting in lower write throughput or the like. Accordingly, distributed transactions on large storage systems lowers the performance of large storage systems.

Accordingly, what is needed are improved techniques to manage secondary indexes in distributed storage systems.

### SUMMARY

In various embodiments, one or more non-transitory computer-readable media store instructions that, when executed by one or more processors, causes the one or more processors to perform a method for supporting consistent secondary indexes, the method comprising receiving, at a first node, a write request comprising a data entry, storing the data entry in an in-memory structure separate from a primary structure for storing the data entry, generating, based on the data entry, a secondary index data entry for a secondary index, and transmitting the secondary index data entry to a second node for inclusion in the secondary index.

In various embodiments, one or more non-transitory computer-readable media store instructions that, when executed by one or more processors, causes the one or more processors to perform a method for supporting consistent secondary indexes, the method comprising receiving, at a first node, a write request comprising a data entry, storing the data entry in a first storage structure, in response to determining that the data entry was written to the storage structure after a first snapshot was generated, generating a secondary index entry based on the data entry, and transmitting the secondary index entry to a second node for inclusion in the secondary index.

In various embodiments, one or more non-transitory computer-readable media store instructions that, when executed by one or more processors, causes the one or more processors to perform a method for supporting consistent secondary indexes, the method comprising receiving, by a first node, a read request comprising a secondary index key, querying, in the first node and based on the secondary index key, a secondary index associated with the secondary index key, transmitting, to at least a second node, a query to identify one or more data entries matching the secondary index key that have not been updated to the secondary index, merging one or more results obtained from the secondary index and the query transmitted to the first node to obtain a set of data entries associated with the read request, and returning the merged one or more results.

Other embodiments include, without limitation, systems and methods the implement one or more aspects of the disclosed techniques.

At least one technical advantage of the disclosed techniques relative to the prior art techniques is that the disclosed techniques enable secondary indexes in distributed storage systems to maintain consistency without relying on distributed transactions that are costly to implement over multiple across the distributed storage system. In particular, by using an orchestrator module to update secondary indexes in the background, and to provide results for secondary index-based queries, the distributed storage system is able to quickly acknowledge writes to the storage system while still maintaining consistency and correctness for queries based on the secondary index. Further, by storing the entries that have not been added to the secondary index in one or more in-memory tables, queries on the secondary index can maintain consistency and correctness without having to make time-consuming accesses to secondary storage. Additionally, by performing a delta scan of the primary index based on a snapshot taken after previous updates to the secondary index, the distributed database may quickly maintain consistency by focusing only on a subset of the primary index that has not yet been used to update the secondary index. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating an example distributed data storage system configured to implement one or more aspects of the present embodiments of the present disclosure.

FIG. 2 illustrates a response to a received write or update request using an example distributed data storage system of FIG. 1, according to various embodiments of the present disclosure.

FIG. 3 illustrates another response to a received write or update request using an example distributed data storage system of FIG. 1, according to various embodiments of the present disclosure.

FIG. 4 illustrates a response to a received read or scan request using an example distributed data storage system of FIG. 1, according to various embodiments of the present disclosure.

FIG. 5 is a flow diagram of method steps for handling write or update requests using an in-memory structure of a node, according to various embodiments of the present disclosure.

FIG. 6 is a flow diagram of method steps for handling write or update requests using a snapshot approach, according to various embodiments of the present disclosure.

FIG. 7 is a flow diagram of method steps for handling queries using a secondary key to a secondary index, according to various embodiments of the present disclosure.

FIGS. 8A-8D are block diagrams illustrating example virtualization system architectures configured to implement one or more aspects of the present embodiments.

FIG. 9 is a block diagram illustrating a computer system configured to implement one or more aspects of the present embodiments.

### DETAILED DESCRIPTION

In the following description, numerous specific details are set forth to provide a more thorough understanding of the various embodiments. However, it will be apparent to one skilled in the art that the inventive concepts can be practiced without one or more of these specific details.

System Overview

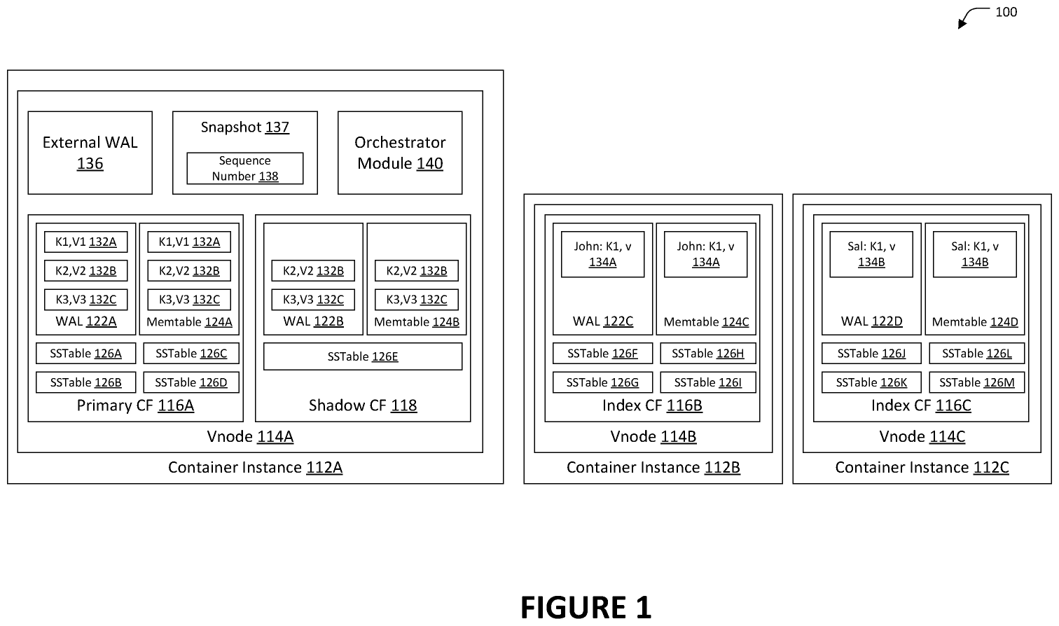

FIG. 1 is a block diagram illustrating an example distributed data store configured to implement one or more aspects of the present embodiments of the present disclosure. As shown, the distributed data storage system 100 includes container instances 112 (e.g., 112A, 112B, 112C), virtual nodes (vnodes) 114 (e.g., 114A, 114B, 114C), column families (CF) 116 (e.g., 116A, 116B, 116C), shadow CF 118, external write-ahead log (WAL) 136, a snapshot 137, a sequence number 138, and orchestrator module 140.

The container instances 112 (e.g., 112A, 112B, 112C) includes portions of a distributed computing system that are allocated processing units and memory from a common resource pool. In some embodiments, each of the container instances can be distributed over a given region, where each container instance 112 includes one or more virtual nodes (vnodes) 114.

The virtual nodes (vnodes) 114 (e.g., 114A, 114B, 114C) are compute nodes that execute various processes. In various embodiments, a given vnode 114 can include one or more CFs 116. In various embodiments, a distributed computing system can manage the deployment of the vnodes 114 and can manage data and services across vnodes within the distributed computing system. In various embodiments, the distributed data storage system 100 can include memory structures, such as CFs 116, 118 that store data for processes run by a given vnode.

The column families (CFs) 116 (e.g., 116A, 116B, 116C) are database objects that contain columns of related data. In various embodiments, each CF 116 can include multiple structures that store data, such as primary and secondary index key-value pairs 132, 134. In various embodiments, the column family includes a series of tuples that form separate key-value pairs. In such instances, the CF 116 can be considered a table, and each key-value pair is an entry or a row in the table. In various embodiments, the primary CF 116 can include different structures, including write-ahead log (WAL) 122, memtable 124, and/or sorted string table(s) (SSTable(s)) 126. In such instances, each of the structures can be searched in order to identify a specific key-value pair using a specific key.

In various embodiments, some container instances 112 can store secondary indexes (e.g., index CFs 116B, 116C) of data that correspond to data stored in a primary CF (e.g., the primary CF 116A) indexed using a secondary index. In such instances, the secondary indexes can index a subset of the data stored in the primary CF. In some embodiments, the secondary index can use a different key than the key used for the primary CF.

The shadow CF 118 can be a separate in-memory structure that replicates at least some of the contents of the primary CF 116A. In various embodiments, the vnode 114A that includes the primary CF 116A can also include the shadow CF 118. In various embodiments, the shadow CF 118 can store the index data for the data included in the primary CF 116A that has not been added to a secondary index.

The write-ahead logs (WALs) 122, 136 (e.g., 122A, 122B, 122C, 122D) are in-memory structures that track changes to data. In various embodiments, the distributed data storage system 100 can use one or more WALs 122 in order to provide atomicity and durability in a database system by first recording changes to data (e.g., write, update, etc.) in a given WAL 122, 136 before such changes are written to other destinations, such as persistent storage or to secondary indexes. For example, new key-value pairs could first be written to the WAL 122A before being written to persistent storage (e.g., SSTable 126A). In another example, a new primary key-value pair could be stored in an external WAL 136 (e.g., a WAL external to the primary CF 116A) before corresponding secondary index information is transmitted to the index CFs 116B, 116C.

The memory tables (memtables) 124 (e.g., 124A, 124B, 124C, 124D) are in-memory structures that store data written by one or more modules. In various embodiments, a given memtable 124 can temporarily store data for limited periods before the data is flushed. For example, a memtable 124B could temporarily store key-value pairs until the stored key-value pairs are transmitted to other nodes (e.g., WALs 122C, 122D in the secondary indexes). In another example, primary key-value pairs stored in the memtable 124A could be transferred to a SSTable 126 (e.g., the SSTable 126D).

The SSTable 126 (e.g., 126A-126M) can store immutable data files that persist data within the distributed data storage system 100. In various embodiments, a given SSTable 126 can store key-value pairs in a sorted or indexed list, a log-structured merge tree, and/or the like. In such instances, the stored key-value pairs can be sorted by a unique key, such as a primary key (e.g., K1, K2, K3, etc.). In some embodiments, the primary key can be a unique sequence number. In some embodiments, each of the SSTables 126 can be a common size (e.g., 64 KB). Additionally or alternatively, the SSTables 126 could include a block index at the end of the table that is used to locate specific blocks and/or specific entries. In some embodiments, a given SSTable 126 can be mapped into memory.

The primary key-value pairs 132 (e.g., 132A, 132B, 132C) link a specific key to one or more data values. In some embodiments, the value in the key-value pair can include a set of values (e.g., a personal record containing a name, address, email, etc.). The secondary index key-value pairs 134 (e.g., 134A, 134B) correspond to primary key-value pairs 132 stored in the primary CF.

A key in a given key-value pair is an index at which a corresponding value can be found. In some embodiments, the keys are binary based, the keys are alphanumeric, and/or a hash of a parameter. In various embodiments, the key included in a given secondary index key-value pair can differ from the key used in the corresponding primary key-value pair. For example, the primary key-value pair 132A could have K1 as a key, with the corresponding secondary index key-value pair 134A having one of the values in the primary key-value pair (e.g., a first name) as the key (“John”). In some embodiments, different secondary indexes can use different keys. For example, a different secondary index (not shown) can use a different value (e.g., phone number) from the as the key for the secondary index.

The snapshot(s) 137 indicate the state of the primary CF at a particular point in time when each primary key-value pair 132 is indexed at the index CFs 116B, 116C. In various embodiments, the primary CF 116A can maintain a temporal ordered list of primary key-value pairs 132 as the primary key-value pairs 132 are indexed into the index CFs 116B. The temporal ordered list can include sequence numbers that correspond to the order of the primary key-value pairs 132 within the ordered list. In such instances, the snapshot 137 includes a sequence number 138 that corresponds to the sequence number of the last primary key-value pair 132 at the time that the snapshot 137 was taken. In some embodiments, the orchestrator module 140 can identify primary key-values pairs 132 for indexing at the index CFs 116B, 116C by identifying the sequence number 138 included in the snapshot 137 and scanning the primary CF 116A beginning at the identified sequence number. In some embodiments, each of the snapshots 137 can include a timestamp of the time that the snapshot was taken and/or a unique snapshot identifier (ID), with subsequent snapshot IDs indicating later points in time.

Orchestrator module 140 is a hardware and/or software module within a given container instance 112 and/or vnode 114 that manages the read and write operations of a given vnode 114. In some embodiments, the orchestrator module 140 can manage the movement and/or copying of data between structures within the same vnode 114 and/or different vnodes 114. For example, the orchestrator module 140 could manage the container instance 112A receiving a write request by causing the primary CF 116A to add the applicable key-value pair included in the write request into memory and/or persisting the key-value pair in an in-memory structure that is separate from the primary CF 116A. In another example, the orchestrator module (not shown) included in the vnode 114B could cause the vnode 114B to provide a strictly-consistent response to a received read request by retrieving results from the secondary index (e.g., index CF 116B) and/or results from other indexes (e.g., primary CF 116A, index CF 116C, shadow CF 118) and merging the set of results into a single response.

### Management of Consistent Indexes without Transactions

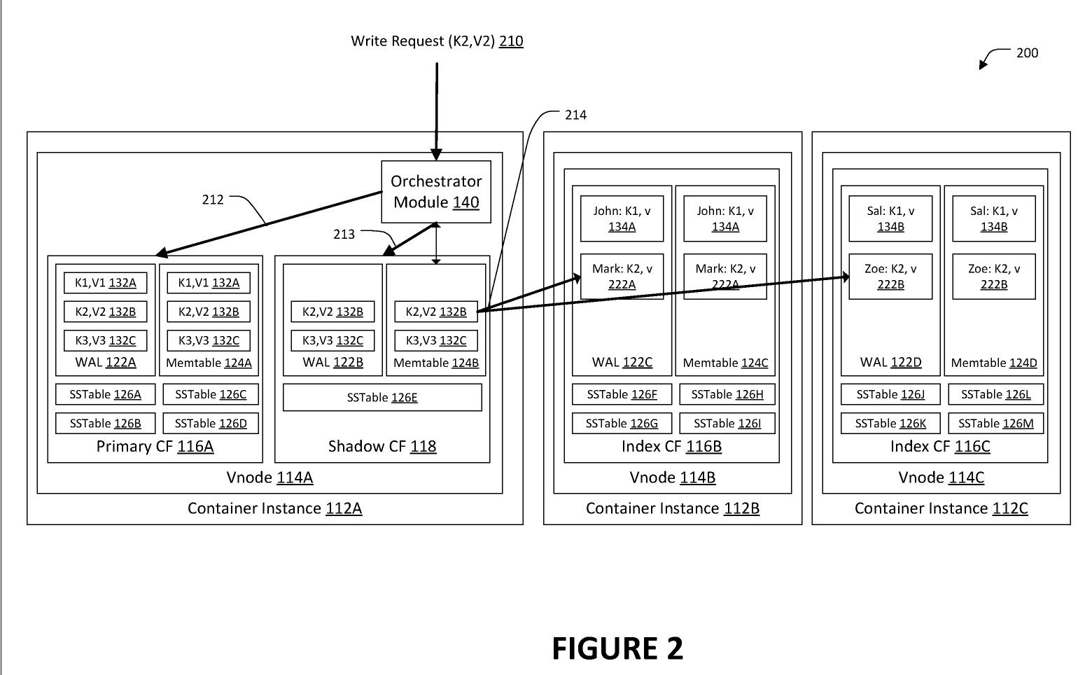

FIG. 2 illustrates a response to a received write or update request using an example distributed data storage system 100 of FIG. 1, according to various embodiments of the present disclosure. As shown, the distributed data storage system 200 further receives a write request 210 and performs write operations 212-214 to generate secondary index key-value pairs 222 (e.g., 222A, 222B).

In operation, the orchestrator module 140 handles an incoming write or update request (e.g., write request 210) by causing the vnode 114A to store a key-value pair included in the write request to the primary CF (e.g., primary CF 116A). The orchestrator module 140 further causes this primary key-value pair to be stored in a separate in-memory structure until secondary indexes are updated. In some embodiments, the in-memory structure is in a different column family, such as the memtable 124B in the shadow CF 118. In other embodiments, the in-memory structure can be the external WAL 136. Once the primary key-value pair 132 is stored in the in-memory structure, the orchestrator module 140 performs various background operations to read the primary key-value pairs that are stored in the in-memory structure, generate secondary index key-value pairs from the primary key-value pairs, and transmit the generated secondary index key-value pairs 134, 222 to the vnodes responsible for storing the respective secondary index key-value pairs 134, 222 in the respective secondary index (e.g., index CFs 116B, 116C). The orchestrator module 140 can then remove the primary key-value pair 132 from the in-memory structure. Although the disclosed embodiments discuss storage systems based on data entries that use key-value pairs stored in column families, the disclosed techniques are applicable to other types of data storage arrangements, including storage systems based on data entries stored as rows in tables, various tuples, ordered pairs, and/or the like.

The write request 210 is a message transmitted from a requester, such as a client device (not shown) to add an entry into a primary index, such as the primary CF 116A. In some embodiments, the write request 210 can be an update request to modify an entry that is stored in the primary CF 116A. The write request 210 can include a key-value pair that specifies a specific set of a key (K2) and a corresponding value (V2) that are to be stored in the primary CF 116A. In some embodiments, two or more values can be included in the key-value pair. In such instances, the key-value can include a single key and the set of two or more values.

Upon receiving the write request 210, the orchestrator module 140 performs various write operations 212, 213 to store the key-value pair in the primary CF 116A and separate in-memory structure. In various embodiments, the orchestration module 140 performs a write operation 212 to cause the key-value pair included in the write request to be added as an entry to the primary CF 116A. In some embodiments, the new entry in the primary CF 116A is a primary key-value pair that receives a new, unique sequence number upon being added to the primary CF 116A.

Additionally, the orchestrator module 140 performs a write operation 213 to store the primary key-value pair in a separate in-memory structure. In various embodiments, the orchestrator module 140 may, upon performing the write operation 212 to add/update the key-value pair to the primary CF 116A, cause the in-memory structure to store the key-value pair corresponding to the primary key-value pair stored in the primary CF 116A until secondary indexes (e.g., index CFs 116B, 116C, etc.) are updated.

In some embodiments, the in-memory structure can be a separate column family, such as a shadow CF 118. In such instances, the orchestrator module 140 can perform the write operation 213 to cause the primary key-value pair (K2, V2) that was added to the primary CF 116A to be added to the respective WAL 122B and memtable 124B that are included in the shadow CF 118. Alternatively, in other embodiments, the in-memory structure can be the external WAL 136. In such instances, the orchestrator module 140 can perform the write operation 213 to cause the primary key-value pair that was added to the primary CF 116A to be added to the external WAL 136.

Periodically, the orchestrator module 140 performs one or more background operations to update secondary indexes to be consistent with the recently added data. In such instances, the orchestrator module 140 can refer to the in-memory structure to identify the primary key-value pairs in the primary CF 116A that need corresponding updates in the secondary indexes. Upon updating the secondary indexes, the orchestrator module 140 can then remove the primary key-value pairs from the in-memory structure. In some embodiments, the orchestrator module 140 can initially determine whether to perform the background operation by initially determining whether other operations associated with the primary CF 116A and/or the separate in-memory structure are occurring (e.g., performing additional writes to the primary CF 116A). In such instances, the orchestrator module 140 determines not to perform the background operation and waits for an additional period.

When performing the background operations, the orchestrator module 140 generates secondary index information from the primary key-value pair. In various embodiments, the orchestrator module 140 performs background operations to generate secondary index information (e.g., one or more secondary index keys and one or more secondary index values) based on the primary key-value pair stored in the in-memory structure. In such instances, the orchestrator module 140 can generate one or more secondary index keys and/or index values according to the secondary indexes that are to be updated.

For example, the orchestrator module 140 could generate, from the primary key-value pair 132B stored in the memtable 124B, two separate secondary index key-value pairs 222A, 222B. In some embodiments, the secondary index key-value pairs 222A, 222B can be using different values as the secondary index key. For example, the first secondary index key-value pair 222A could be for one secondary index (e.g., index CF 116B) that uses values from a first field (e.g., first name) as a secondary index key, and the secondary index key-value pair 222B could be for a different secondary index (e.g., index CF 116C) that uses values from a second field (e.g., middle name) as a secondary index key. In other embodiments, the secondary index key-value pairs 222A, 22B can be two separate secondary index key-value pairs based on the same primary key-value pair 132B.

Once the secondary index information is created, the orchestrator module 140 performs actions 214 to update the secondary indexes with the secondary index key-value pairs. In various embodiments, the orchestrator module 140 performs various actions 214 to cause the secondary index information generated in the in-memory structure to be transmitted to the secondary indexes (e.g., index CFs 116B, 116C). In some embodiments, the orchestrator module 140 causes the secondary index keys and secondary index value pairs 222A, 222B to be transmitted to the WALs 122C, 122D included in the respective secondary indexes (e.g., index CFs 116B, 116C). Upon causing the secondary indexes and values to be transmitted from the in-memory structure, causes the primary key-value pair to be removed from the in-memory structure.

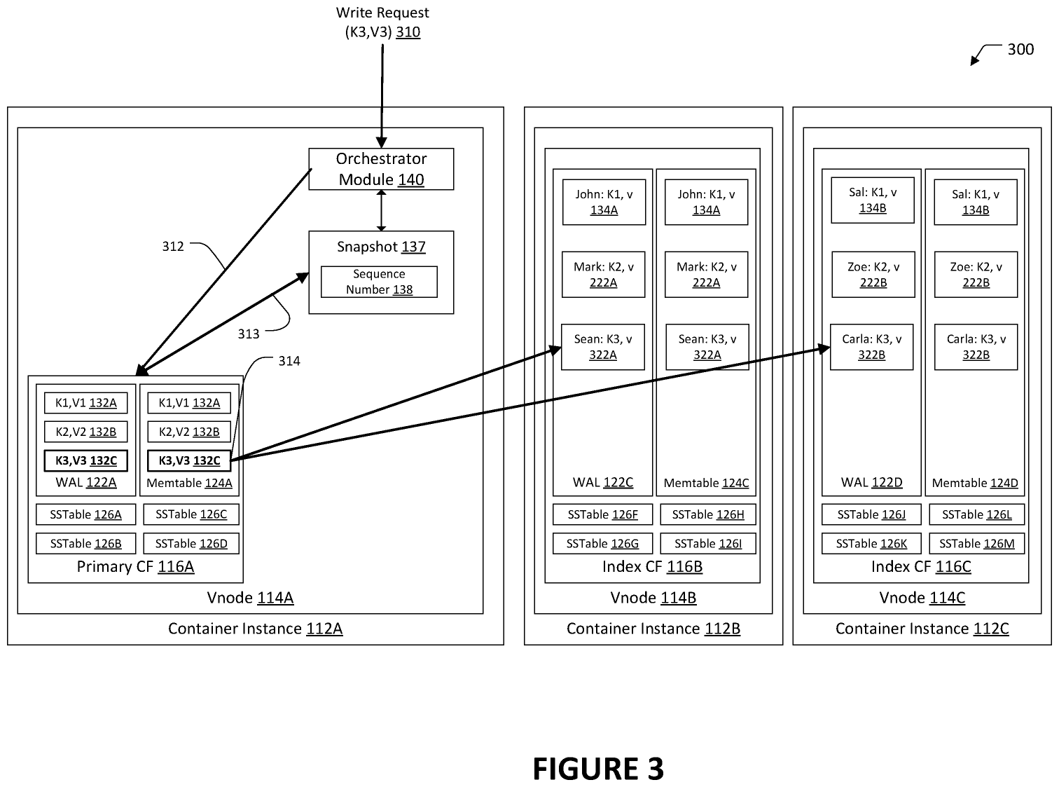

FIG. 3 illustrates another response to a received write or update request using an example distributed data store of FIG. 1, according to various embodiments of the present disclosure. As shown, the distributed data storage system 200 receives a write request 310 and performs write operations 312-314 to generate secondary index key-value pairs 322 (e.g., 322A, 322B).

In operation, the orchestrator module 140 periodically updates the secondary indexes (e.g., index CFs 116B, 116C) based on updated primary key-value pairs 132 in the primary CF. When the updates to the secondary indexes are complete, the orchestrator module 140 generates a snapshot 137 of the primary CF 116A that identifies the last sequence number 138 of the primary key-value pair in the primary CF 116A for which secondary indexes have been generated. When the vnode 114A subsequently receives a write request, the orchestrator module 140 writes the key-value pair to the primary CF as a primary key-value pair 132C and assigns a new sequence number for the primary key-value pair 132C that is subsequent to the sequence number 138.

When the orchestrator module 140 does periodic background operations to update the secondary indexes, the orchestrator module 140, instead of searching the entire primary CF, performs a delta scan of the primary CF 116A in order to identify a subset of primary key-value pairs 132 within the primary index that have not been indexed at the secondary indexes (e.g., the primary key-value pair 132C, etc.) by identifying a subset of sequence numbers past the sequence number 138 included in the previous snapshot 137. The orchestrator module 140 then updates the secondary indexes in the order of the sequence numbers with secondary index key-value pairs 322 and generates a new snapshot with a new sequence number (e.g., the sequence number of the last primary key-value pair for which secondary indexes have been created).

In various embodiments, the vnode 114A can receive a write request 310 that includes a key-value pair that is to be added to the primary CF. For example, the vnode 114A could receive the write request 310 to add the included key-value pair of (K3, V3) as an entry into the primary CF 116A. In such instances, the orchestrator module 140 can handle the write request 310 received by the vnode 114A. The write request 310 is a message transmitted from a requester, such as a client device (not shown) to add the included key-value pair into the database table, such as the primary CF 116A. In some embodiments, the write request 310 can be an update request to modify an existing key-value pair that is already stored in the primary CF 116A. The write request 310 can include a key-value pair that specifies a specific mapping of a key (K3) to a value (V3) that are to be stored in the primary CF 116A. In some embodiments, the value can encompass two or more discrete values (e.g., first name, middle name, last name, etc.). In such instances, the key-value pair can include a single key and the value as a set of the two or more discrete values.

Upon receiving the write request 310, the orchestrator module 140 performs various write operations 312 to add the received key-value pair into the primary CF as a primary key-value pair 132. In various embodiments, the orchestrator module 140 can manage the write request 310 received by the vnode 114A by performing one or more write operations 312 that cause the key-value pair included in the write request 310 to be added to the primary CF 116A as a primary key-value pair 132 (e.g., primary key-value pair 132A). In such instances, the key-value pair can be added to the primary CF 116A and be assigned a unique sequence number indicating a temporal order at which the primary key-value pairs 132 are to be indexed by the secondary indexes.

In various embodiments, upon adding the primary key-value pair 132C to the primary CF 116A, the orchestrator module 140 can perform various background operations to update the secondary indexes (e.g., index CFs 116B, 116C) based on the primary key-value pairs 132 in the primary CF. In such instances, the orchestrator module 140 can perform a delta scan 313 of the primary index based on one or more snapshots 137 associated with the primary index. In various embodiments, the orchestrator module 140 can generate a new snapshot 137 upon successfully updating the secondary indexes. The generated snapshot 137 can include, among other things, a timestamp indicating when the snapshot was generated (and when the secondary indexes were last updated), a snapshot identifier, and/or a sequence number that corresponds to the sequence number of the last primary key-value pair 132 in the primary CF 116A that was indexed at the secondary indexes before the snapshot 137 was generated. In such instances, the orchestrator module 140 can perform a delta scan 313 based on the snapshot 137 in order to identify a subset of primary key-value pairs stored in the primary CF 116A that require updates at the corresponding secondary indexes. In some embodiments, each secondary index being maintained by distributed data storage system 200 may have its own separate snapshot 137 and/or sequence number 138.

For example, the primary key-value pairs 132A, 132B could have previously been updated at the secondary indexes and the orchestrator module 140 could have generated the snapshot 137, where the sequence number 138 included in the snapshot 137 includes the sequence number for the primary key-value pair 132B. When the orchestrator module 140 subsequently performs background operations to update the secondary indexes, the orchestrator module 140 could perform a delta scan 313 on the primary CF 116A by retrieving the sequence number 138 from the snapshot 137 and scanning entries of the primary CF 116A, starting at the sequence number subsequent to the sequence number 138. Based on the delta scan 313, the orchestrator module 140 could then identify a subset of primary key-value pairs 132 (e.g., the primary key-value pair 132C) with subsequent sequence numbers, indicating that such primary key-value pairs need updates in the secondary index.

For each identified sequence number, the orchestrator module 140 performs background operations to generate secondary index information from the primary key-value pair 132 (e.g., generating secondary index key-value pairs 332A, 322B based on the primary key-value pair 132C). In various embodiments, the orchestrator module 140 can perform background operations to generate secondary index information (e.g., one or more secondary index keys and one or more secondary index values) based on the primary key-value pair 132C stored in the primary CF 116A that is yet to be indexed at the secondary indexes. In such instances, the orchestrator module 140 can generate one or more secondary index keys and/or index values 322A, 322B according to the secondary indexes that are to be updated (e.g., index CFs 116B, 116C). In some embodiments, the orchestrator module 140 can generate, from the primary key-value pair 132C stored in the primary CF 116A, two separate secondary index key-value pairs 322A, 322B. In some embodiments, the two secondary index key-value pairs 222A, 222B can be using different values as the secondary index key.

Once the secondary index information is created, the orchestrator module 140 performs write actions 314 to update the secondary indexes with the secondary index key-value pairs 322A, 322B by transmitting the respective secondary index key-value pairs 322A, 322B to the WALs 122C, 122D included in the respective secondary indexes (e.g., index CFs 116B, 116C). In some embodiments, the orchestrator module 140 can respond to the secondary index information being transmitted to the secondary indexes by generating a new snapshot 137. In such instances, the snapshot 137 can include a new sequence number (e.g., the sequence number corresponding to the primary key-value pair 132C) indicating the sequence number of the last primary key-value pair 132 in the primary CF 116A that has been indexed in the secondary indexes with corresponding secondary index key-value pairs 322A, 322B.

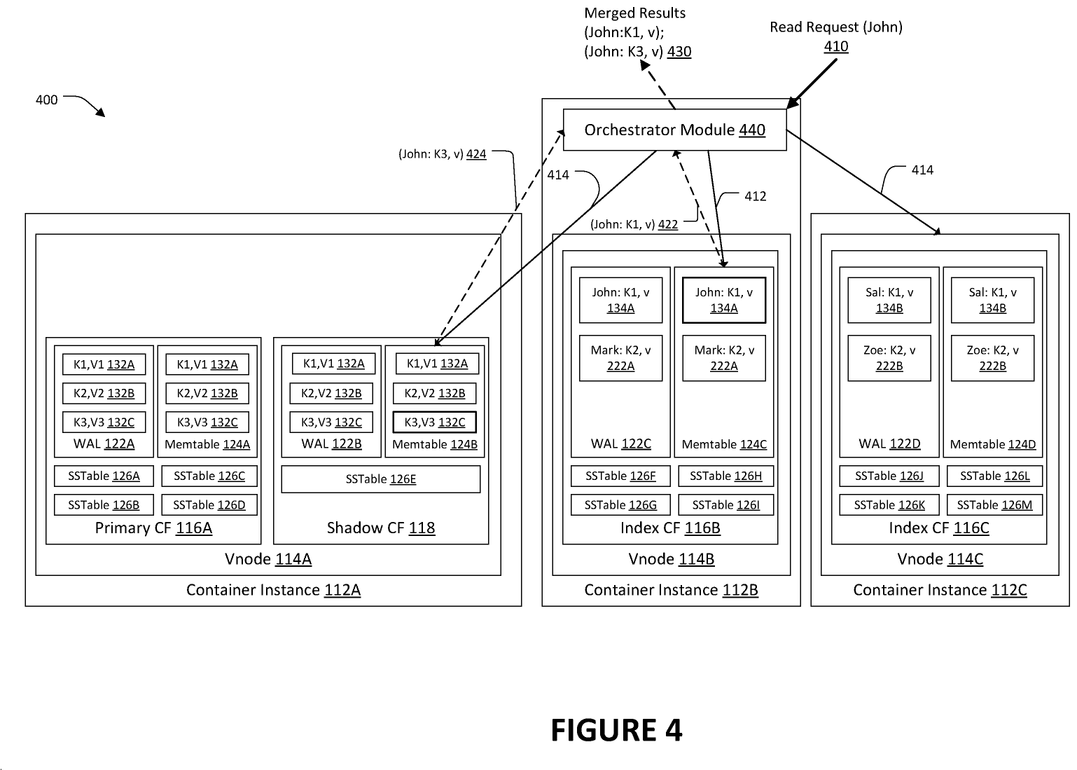

FIG. 4 illustrates a response to a received read or scan request using the example distributed data store of FIG. 1, according to various embodiments of the present disclosure. As shown, the distributed data storage system 400 further receives a read request 410 and performs queries 412, 414 to generate query results 422, 424, merged results 430.

In various embodiments, a given container instance 112 (e.g., container instance 112B) can respond to a received read request or scan request 410 by performing one or more queries based on a secondary index key that is included in the read request 410. In various embodiments, an orchestrator module 440 included in the container instance 112B and/or the vnode 114B can cause the vnode 114B included in the container instance 112B, as well as one or more other nodes (e.g., vnodes 114A, 114C) in the distributed data storage system 400 to perform a set of queries based on the secondary index key included in the read request 410. In some embodiments, the set of queries 412, 414 triggered by the orchestrator module 440 includes a scan on the secondary index (e.g., index CF 116B) using the secondary index key. Additionally or alternatively, the set of queries 412, 414 can include one or more scatter-gather listing operations on the in-memory structures included in one or more other nodes (e.g., vnodes 114A, 114C). Such in-memory structures store primary key-value pairs 132 that have not been added to the secondary indexes (e.g., index CFs 116B, 116C) and are associated with the secondary index key. In such instances, the orchestrator module 440 receives results 422, 424 from the set of queries 412, 414 and merges the results into a set of merged results 430.

In various embodiments, a given container instance 112B can receive a read request 410. The read request 410 can include a secondary index key (e.g., “John”) instead of a primary index key, where the secondary index key is applicable to the index CF 116B included in the container instance 112B. In some embodiments, the orchestrator module 440 can process the received read request 410. In some embodiments, the orchestrator module 440 can respond to the read request 410 by performing actions to initiate a set of queries 412, 414. In such instances, the orchestrator module 440 can initiate a query 412 of the secondary index (e.g., index CF 116B) that is included in vnode 114B using the secondary index key. For example, the query 412 made on the index CF 116B could be a scan of the WAL 122C and/or memtable 124C (included in the index CF 116B) using the secondary index key. In various embodiments, the secondary index key can cause the orchestrator module 440 to identify a result 422 that includes at least one entry (e.g., the secondary index key-value pair 134A of (John: K1, v)) that is included in the index CF 116B that corresponds to a secondary index key-value pair.

In various embodiments, the orchestrator module 440 can perform another set of queries 414 to identify entries in other nodes (e.g., vnodes 114A, 114C) using the secondary index key. In such instances, the orchestrator module 440 can cause the other nodes to perform queries 414, such as scatter-gather listing operations, on the in-memory structures (e.g., memtables 124A, 124B, 124D and/or external WAL 136) that store primary key-value pairs 132 that have not been used yet to update the secondary indexes. In various embodiments, other nodes can perform queries associated with the secondary index key by identifying corresponding primary key-value pairs 132 stored in the in-memory structures where corresponding updates to the secondary indexes have not yet occurred. Upon identifying such a matching primary key-value pair in the in-memory structure, the other node can generate results (e.g., result 424) that includes at least one entry (e.g., the primary key-value pair 132A of (John: K1, v)) that is included in the shadow CF 118 that corresponds to the secondary index key, but has not yet been used to generate secondary index key-value pairs.

In various embodiments, the secondary indexes (e.g., index CFs 116B, 116C) may not be consistent with the primary CF (e.g., primary CF 116A) or the in-memory structure storing the primary key-value pairs 132 that are not yet included in the secondary indexes. In such instances, the results 422, 424 generated from the separate queries may differ. For example, the primary key-value pair 132A could have been updated, but the secondary index information may not have been transmitted to the secondary indexes. In such instances, the orchestrator module 440 can merge the received results 422, 424 into a set of merged results 430. The set of merged results 430 can be used to respond to the read request 410 with both the secondary index information (e.g., secondary index key-value pair 134A), as well as the updated primary key-value pair 132A from the primary CF. In one example, the vnode 114A including the primary CF 116A could generate results that includes the primary key-value pair 132 (e.g., the primary key-value pair 132A) from an in-memory structure that is separate from the primary CF 116A.

Alternatively, the orchestrator module 140 included in the vnode 114A could respond to receiving a request from the orchestrator module 440 in the container instances 112B by using a delta scan to identify the sequence number 138 included in the most-recent snapshot 137 and scanning the primary CF 116A from that sequence number 138 in order to identify a primary key-value pair 132A that matches the secondary index key, but has not yet been used to update the secondary index in index CF 116B. In the cases where the orchestrator module 140 could generate results 424 that include the matching primary key-value pair 132A, the orchestrator module 140 returns the primary key-value pair 132A in the generated results 424 to the orchestrator module 440, where the orchestrator module 440 merges the results 424 with the results 422 acquired from querying the secondary index in index CF 116B.

When the orchestrator module 440 provides the merged results 430, the distributed data storage system 400 can maintain strict consistency when responding to received read or scan requests 410 without requiring that the distributed data storage system 400 actively update the secondary index immediately after every write request (e.g., the write requests 210, 310). Further, having the orchestrator module 440 initiate queries at the in-memory structures of the other nodes and/or using delta scans enables the distributed data storage system 400 to provide fast results, as the queries 414 at the other nodes search a small subset of in-memory structures in lieu of searching entire indexes.

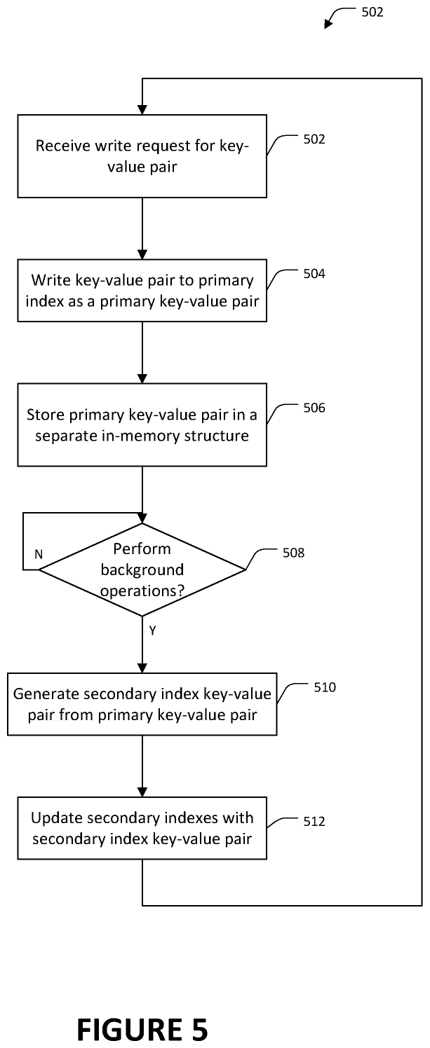

FIG. 5 is a flow diagram of method steps for handling write or update requests by the distributed data storage system 100, according to various embodiments of the present disclosure. Although the method steps are described in conjunction with the systems of FIGS. 1-4, persons skilled in the art will understand that any system can be configured to perform the method steps in any order.

As shown, method 500 begins at step 502, where the orchestrator module 140 receives a write request for a key-value pair. In various embodiments, the orchestrator module 140 in a node, such as vnode 114A, can receive a write request 210 to add an entry into a primary CF, such as the primary CF 116A. In such instances, the orchestrator module 140 can handle the write request 210 received by the vnode 114A.

At step 504, the orchestrator module 140 writes the received key-value pair into the primary CF 116A as a primary key-value pair. In various embodiments, the orchestrator module 140 manages the write request 210 received by the vnode 114A by causing the key-value pair included in the write request 210 to be added as an entry to the primary CF 116A. In such instances, the key-value pair can be added to the primary CF 116A as a primary key-value pair 132 (e.g., primary key-value pair 132B). In some embodiments, the key-value pair can be added to both the WAL 122A and the memtable 124A included in the primary CF 116A.

At step 506, the orchestrator module 140 stores the primary key-value pair 132B in a separate in-memory structure. The orchestrator module 140 can cause the separate in-memory structure to store the primary key-value pair 132B that is stored in the primary CF 116A in the separate in-memory structure until secondary indexes (e.g., index CFs 116B, 116C, etc.) are updated.

In some embodiments, the in-memory structure can be a separate column family, such as a shadow CF 118. In such instances, the orchestrator module 140 can cause the primary key-value pair 132B that was added to the primary CF 116A to be added to the respective WAL 122B and memtable 124B that are included in the shadow CF 118. Alternatively, in other embodiments, the in-memory structure can be an external WAL 136. In such instances, the orchestrator module 140 can cause the primary key-value pair 132B that was added to the primary CF 116A to be added to the external WAL 136.

At step 508, the orchestrator module 140 determines whether to perform background operations. In various embodiments, the orchestrator module 140 can determine, at periodic intervals, whether to perform one or more background operations to update secondary indexes (e.g., index CFs 116B, 116C) to be consistent with the primary CF 116A. In some embodiments, the orchestrator module 140 can determine whether other operations associated with the primary CF 116A and/or the separate in-memory structure are occurring (e.g., handling additional write requests). In such instances, the orchestrator module 140 determines not to perform the background operation and waits for a period before repeating step 508. Otherwise, the orchestrator module 140 determines that the background operations are to be performed and proceeds to step 510.

At step 510, the orchestrator module 140 generates a secondary index key-value pair 222 from the primary key-value pair 132B. In various embodiments, the orchestrator module 140 performs various operations to generate secondary index information (e.g., secondary index key(s) and secondary index value(s)) based on the primary key-value stored in the in-memory structure. In such instances, the orchestrator module 140 can generate one or more secondary index keys and/or index values according to the secondary indexes that are to be updated. For example, the orchestrator module 140 can generate one secondary index key using a value from a first field (e.g., first name) for a secondary index key-value pair 222A for one secondary index (e.g., index CF 116B) included in vnode 114B, and can generate a different secondary index key using a value from a different field (e.g., middle name) for a secondary index key-value pair 222B for a different secondary index (e.g., index CF 116C) included in vnode 114C.

At step 512, the orchestrator module 140 updates the secondary indexes with the secondary key value pair. In various embodiments, the orchestrator module 140 causes the secondary index information generated in the in-memory structure to be transmitted to the secondary indexes. In some embodiments, the orchestrator module 140 causes the secondary index key(s) and secondary index value(s) to be transmitted from the memtable 124B included in the shadow CF 118 to the WALs 122C, 122D included in the respective secondary indexes (e.g., index CFs 116B, 116C) as secondary index key-value pairs 222A, 222B. In other embodiments, the orchestrator module 140 causes the secondary index key(s) and secondary index value(s) to be transmitted from the external WAL 136 to the WALs 122C, 122D included in the respective index CFs 116B, 116C as secondary index key-value pairs 222A, 222B. In some embodiments, the orchestrator module 140, upon causing the secondary index key-value pairs 222 to be transmitted from the in-memory structure, causes the primary key-value pair to be removed from the in-memory structure.

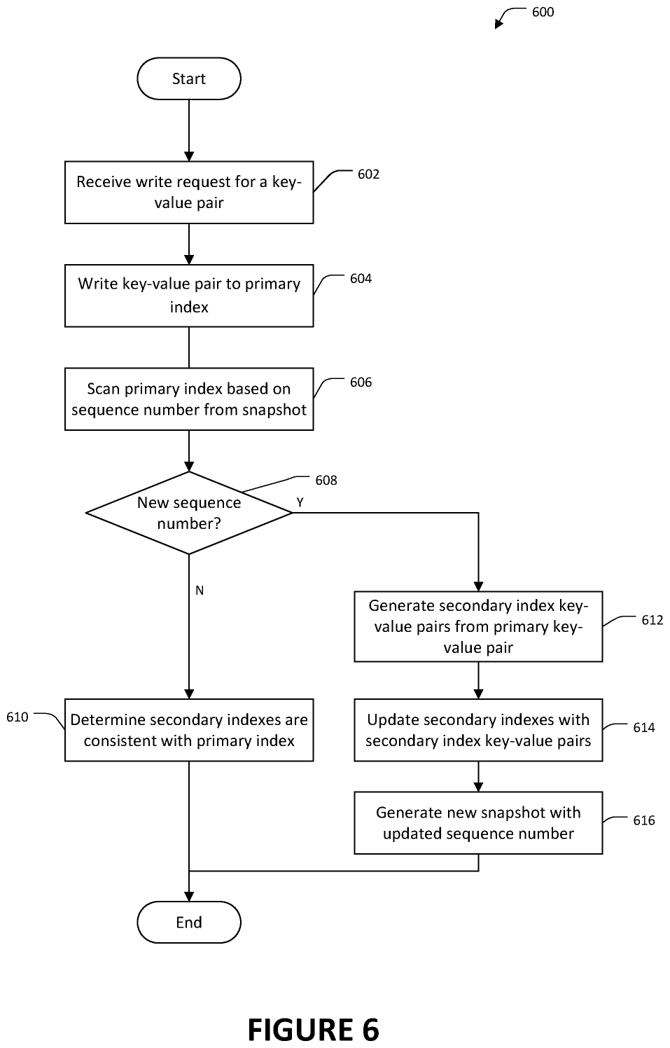

FIG. 6 is a flow diagram of method steps for handling write or update requests using a snapshot generated from the distributed data store of FIG. 1, according to various embodiments of the present disclosure. Although the method steps are described in conjunction with the systems of FIGS. 1-4, persons skilled in the art will understand that any system can be configured to perform the method steps in any order.

As shown, method 600 begins at step 602, where the orchestrator module 140 receives a write request for a key-value pair. In various embodiments, the vnode 114A including the primary index can receive a write request 210 to add a key-value pair to the primary CF. In such instances, the orchestrator module 140 can handle the write request 310 received by the vnode 114A.

At step 604, the orchestrator module 140 writes the received key-value pair into the primary CF as a primary key-value pair 132. In various embodiments, the orchestrator module 140 can manage the write request 310 received by the vnode 114A by causing the key-value pair included in the write request 310 to be added to the primary CF 116A as a primary key-value pair 132. In some embodiments, the key-value pair can be added to the primary CF 116A with a unique sequence number indicating a temporal order of the primary key-value pair 132 relative to other entries in the primary CF 116A.

At step 606, the orchestrator module 140 scans the primary index based on a sequence number included in a snapshot. In various embodiments, the orchestrator module 140 can generate a snapshot upon completing updates of the secondary indexes with the primary key-value pairs 132 in the primary index. In such instances, the snapshot includes a sequence number of the last primary key-value pair 132 for which updates were transmitted to the secondary indexes. The orchestrator module 140 can subsequently perform background operations that include a delta scan of the primary CF 116A in order to identify entries in the primary CF 116A that require updates at the corresponding secondary indexes. In some embodiments, the orchestrator module 140 can perform a delta scan 313 of the primary CF 116A based on the most-recent snapshot 137 by obtaining the sequence number 138 included in the snapshot 137 and scanning through the primary CF 116A from the sequence number 138.

At step 608, the orchestrator module 140 determines whether the primary index includes at least one new sequence number. In various embodiments, the orchestrator module 140 can process the results of the delta scan and can determine whether the primary CF 116A includes one or more new sequence numbers that are subsequent to the sequence number 138 included in the snapshot 137, indicting one or more primary key-pairs that need indexing at the secondary indexes. When the orchestrator module 140 determines that the primary CF 116A contains no new sequence numbers, the orchestrator module 140 proceeds to step 610; otherwise, the orchestrator module 140 determines that the primary CF 116A includes at least one new sequence number and proceeds to step 612.

At step 610, the orchestrator module 140 determines that the secondary indexes are consistent with the primary index. In some embodiments, the orchestrator module 140 can respond to the determination that the primary CF 116A includes no new sequence numbers since the most-recent snapshot 137 (where the secondary indexes were last updated) by determining that no secondary indexes need updates for new primary key-value pairs 132 that are in the primary CF 116A. In such instances, the orchestrator module 140 can determine that the secondary indexes are consistent with the primary CF and end the method 600.

At step 612, the orchestrator module 140 generates secondary index key-value pairs from the primary key-value pair. In various embodiments, the orchestrator module 140 can perform various operations to generate secondary index information (e.g., one or more secondary index key-value pairs 322A, 322B, etc.) based on the identified primary key-value pairs (e.g., the primary key-value pair 132C) stored in the primary index. In such instances, the orchestrator module 140 can generate one or more secondary index keys and/or secondary index values according to the secondary indexes that are to be updated. For example, the orchestrator module 140 could generate one secondary index key for a secondary index key-value pair 322A using a value from a first field (e.g., first name) for one secondary index (e.g., index CF 116B) included in vnode 114B, and can generate a different secondary index key for a secondary index key-value pair 322B using a value from a different field (e.g., middle name) for a secondary index (e.g., index CF 116C) included in vnode 114C.

At step 614, the orchestrator module 140 updates the secondary indexes with the secondary index key-value pairs. In various embodiments, the orchestrator module 140 can cause the secondary index information (e.g., secondary index key-value pairs 322A, 322B) to be transmitted to the to the WALs 122C, 122D included in the respective secondary indexes (e.g., index CFs 116B, 116C).

At step 616, the orchestrator module 140 generates a new snapshot with an updated sequence number. In some embodiments, the orchestrator module 140 causes the vnode 114A to generate a new snapshot in response to the secondary index information being sent to the secondary indexes. In such instances, the new snapshot generated by the orchestrator module 140 can include new information to reflect the state of the primary CF 116A. Such information can include a timestamp, a new snapshot ID, and/or an updated sequence number that corresponds to the last primary key-value pair 132 in the primary CF 116A that was indexed at the secondary indexes (e.g., the sequence number corresponding the to the primary key-value pair 132C). Additionally or alternatively, in some embodiments, one or more of the secondary indexes can have their own respective snapshot (e.g., a snapshot based on the state of the index CF 116B). In such instances, such a snapshot may include a sequence number corresponding to the last secondary index key-value pair (e.g., the secondary index key-value pair 222A) that was indexed at the index CF 116B).

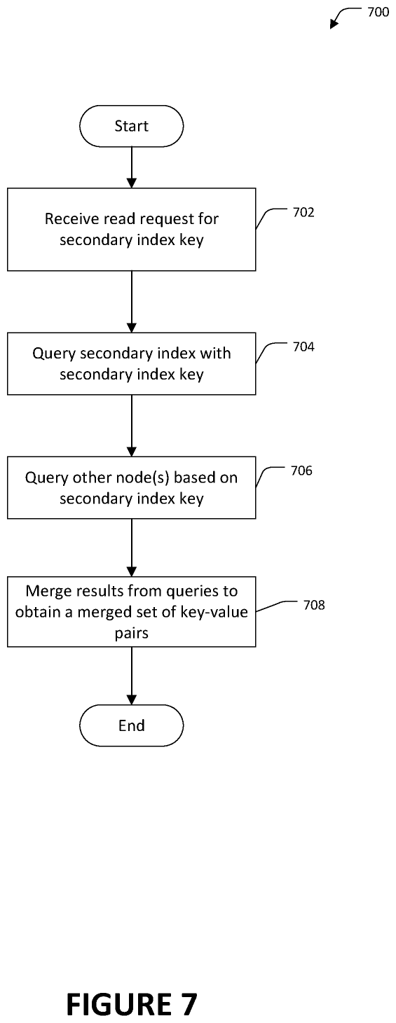

FIG. 7 is a flow diagram of method steps for handling read or scan requests using a secondary key to a secondary index included in the autonomous extent store of FIG. 1, according to various embodiments of the present disclosure. Although the method steps are described in conjunction with the systems of FIGS. 1-4, persons skilled in the art will understand that any system can be configured to perform the method steps in any order.

As shown, method 700 begins at step 702, where a node receives a read request for a secondary index key. In various embodiments, a container instance 112B that includes node (e.g., vnodes 114B) storing a secondary index can receive a read request 410 that includes a secondary index key instead of a primary index key, where the secondary index key is applicable to the secondary index store in the vnode. In some embodiments, an orchestrator module 440 included in the vnode 114B and/or the container instance 112B can process the received read request 410.

At step 704, the orchestrator module 440 in the receiving vnode queries the secondary index with a secondary index key. In various embodiments, the orchestrator module 440 included in the container instance 112B and/or the vnode 114B can initiate a query 412 of the secondary index (e.g., index CF 116B) that is included in vnode 114B using the secondary index key. In some embodiments, the query 412 can be a sequential scan of the index CF 116B using the secondary index key. In various embodiments, the secondary index key can cause the orchestrator module 440 to identify a result 422 that includes at least one entry that is included in the index CF 116B that corresponds to a secondary index key-value pair 134A.

At step 706, the orchestrator module 440 causes queries based on the secondary index key to be performed in other nodes. In various embodiments, the orchestrator module 440 causes operations in one or more other nodes (e.g., vnodes 114A, 114C) to query in-memory structures and/or a specific range of sequence numbers in order to identify primary key-value pairs 132 that correspond to the secondary index key. In such instances, the orchestrator module 440 can cause the other vnodes 114A, 114C to perform scatter-gather listing operations within the vnodes 114A, 114C. In some embodiments, vnodes 114A, 114C performs queries 414 on the in-memory structures (e.g., memtables 124A, 124B, 124D and/or external WAL 136) where primary key-value pairs 132 have been stored, but corresponding secondary index key-value pairs 134, 222, 322 have not been transmitted to the secondary indexes, such as the index CF 116B. In such instances, the vnodes 114A, 114C can identify any of the primary key-value pairs 132 (e.g., the primary key-value pair 132A) that are stored in the in-memory structure. In some embodiments, the vnode 114A containing the primary index can include a sequence number indicating the last entry in the primary CF 116A that was added to the secondary indexes. For example, the vnode 114A could store a snapshot 137 that includes a sequence number 138 indicating a sequence number associated with the primary key-value pair 132A as the last entry for which a secondary index key-value pair were generated. In such instances, the vnode 114A can perform a delta scan to identify a subset of primary key-value pairs 132 past the sequence number 138 and can attempt to identify a primary key-value pair 132 within that subset that matches the secondary index key.

At step 708, the orchestrator module 440 merges results received from the separate queries to obtain a set of primary key-value pairs. In various embodiments, the secondary indexes (e.g., index CFs 116B, 116C) may not be consistent with the primary index (e.g., primary CF 116A) and/or the in-memory structure storing an updated primary key-value pair 132. In such instances, the orchestrator module 440 can receive differing key-value pairs from the results 422 received from the query on the index CF 116B and the results 424 received from queries made at the other nodes. In such instances, the orchestrator module 440 can merge the received results 422, 424 into a set of merged results 430, where the merged results include a secondary index key-value pair from the secondary index (e.g., index CF 116B) and a primary key-value pair. In such instances, the distributed data storage system 100 can respond to a read request that uses a secondary index key with an updated primary key-value pair from the primary index (e.g., from an in-memory structure or from a subset of the primary index based on a sequence number) without requiring that the system actively update the secondary indexes in response to every write request.

### Example Virtualization System

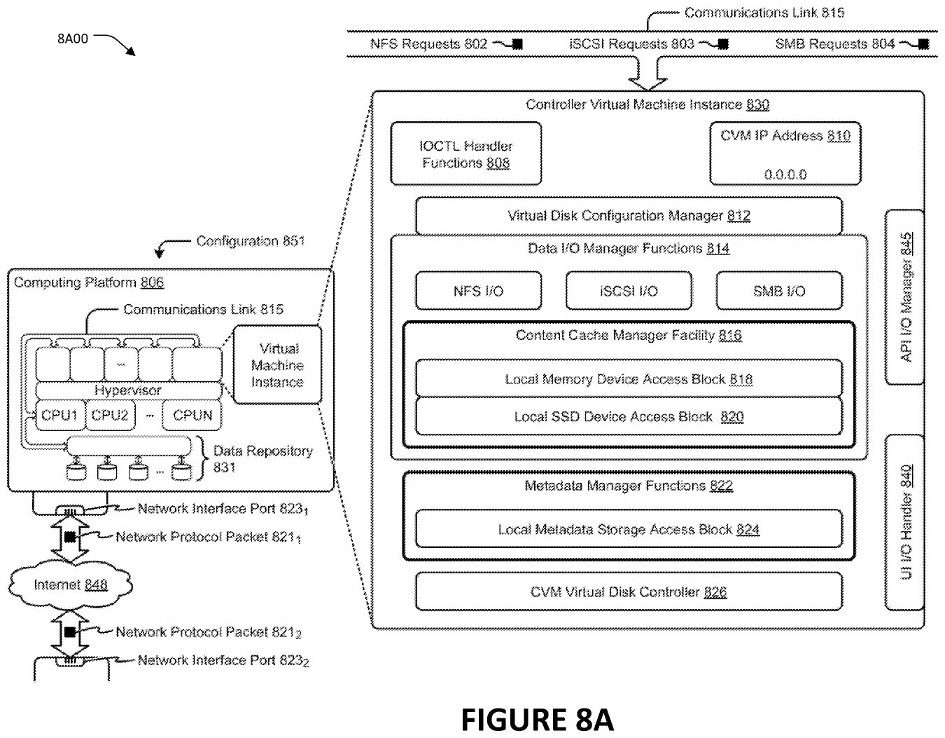

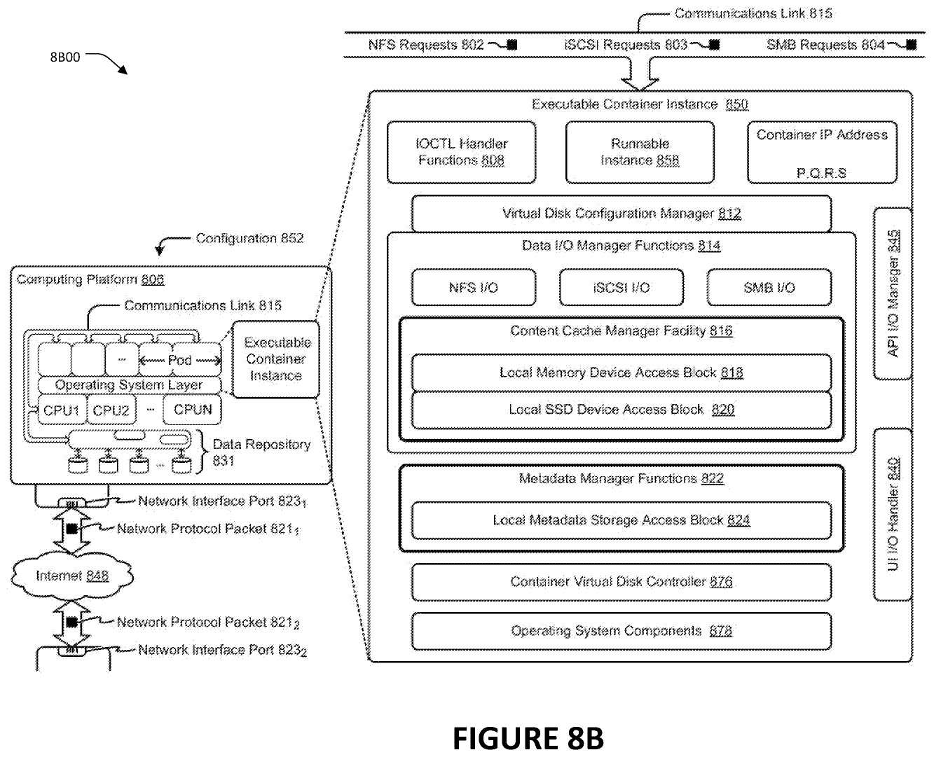

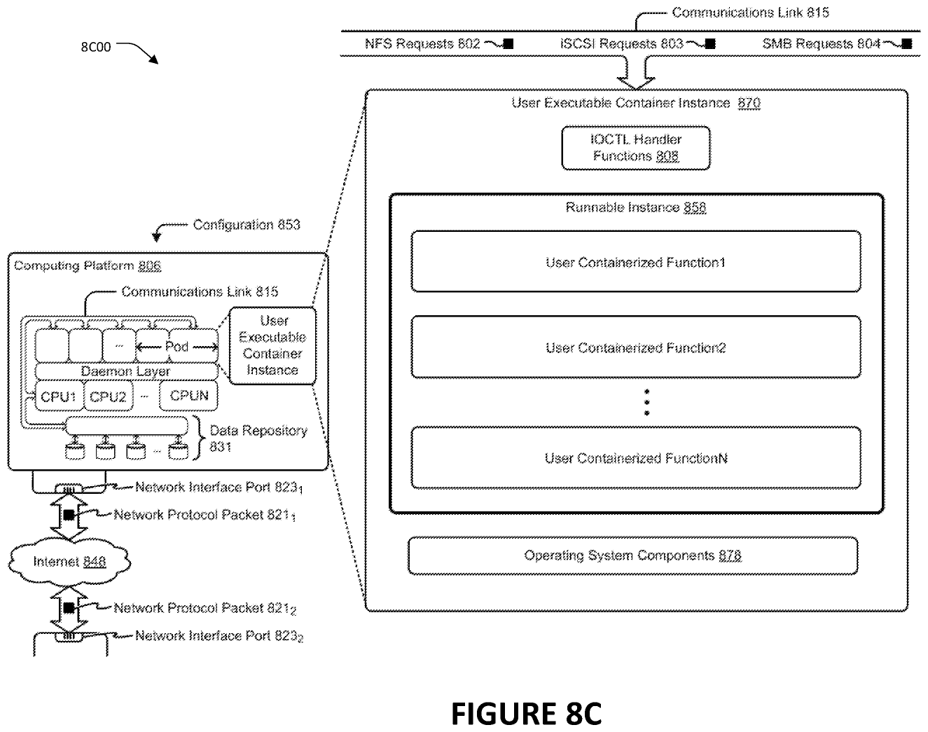

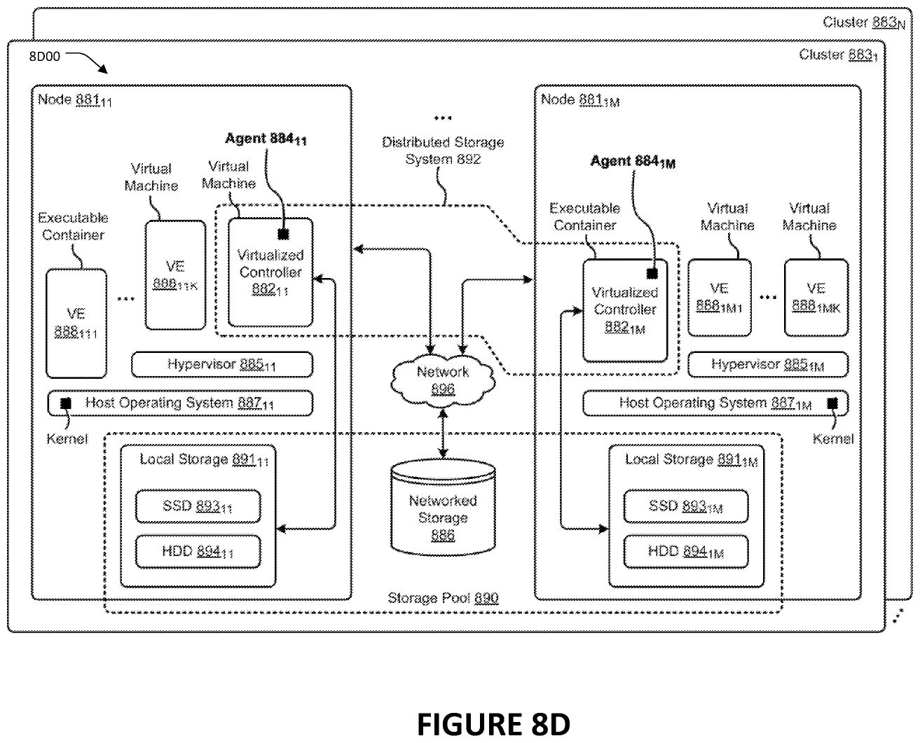

FIG. 8A is a block diagram illustrating virtualization system architecture 8A00 configured to implement one or more aspects of the present embodiments. As shown in FIG. 8A, virtualization system architecture 8A00 includes a collection of interconnected components, including a controller virtual machine (CVM) instance 830 in a configuration 851. Configuration 851 includes a computing platform 806 that supports virtual machine instances that are deployed as user virtual machines, or controller virtual machines or both. Such virtual machines interface with a hypervisor (as shown). In some examples, virtual machines can include processing of storage I/O (input/output or IO) as received from any or every source within the computing platform. An example implementation of such a virtual machine that processes storage I/O is depicted as CVM instance 830.

In this and other configurations, a CVM instance receives block I/O storage requests as network file system (NFS) requests in the form of NFS requests 802, internet small computer storage interface (iSCSI) block IO requests in the form of iSCSI requests 803, Samba file system (SMB) requests in the form of SMB requests 804, and/or the like. The CVM instance publishes and responds to an internet protocol (IP) address (e.g., CVM IP address 810). Various forms of input and output can be handled by one or more IO control handler functions (e.g., IOCTL handler functions 808) that interface to other functions such as data IO manager functions 814 and/or metadata manager functions 822. As shown, the data IO manager functions can include communication with virtual disk configuration manager 812 and/or can include direct or indirect communication with any of various block IO functions (e.g., NFS TO, iSCSI IO, SMB IO, etc.).

In addition to block IO functions, configuration 851 supports IO of any form (e.g., block IO, streaming IO, packet-based IO, HTTP traffic, etc.) through either or both of a user interface (UI) handler such as UI IO handler 840 and/or through any of a range of application programming interfaces (APIs), possibly through API IO manager 845.

Communications link 815 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), formatting of bit fields into fixed-length blocks or into variable length fields used to populate the payload, and/or the like. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry can be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

Computing platform 806 include one or more computer readable media that is capable of providing instructions to a data processor for execution. In some examples, each of the computer readable media can take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory (RANI). As shown, controller virtual machine instance 830 includes content cache manager facility 816 that accesses storage locations, possibly including local dynamic random access memory (DRAM) (e.g., through local memory device access block 818) and/or possibly including accesses to local solid state storage (e.g., through local SSD device access block 820).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 831, which in turn can be formatted into any one or more storage areas, and which can comprise parameterized storage accessible by a key (e.g., a filename, a table name, a block address, an offset address, etc.). Data repository 831 can store any forms of data and can comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 824. The data repository 831 can be configured using CVM virtual disk controller 826, which can in turn manage any number or any configuration of virtual disks.

Execution of a sequence of instructions to practice certain of the disclosed embodiments is performed by one or more instances of a software instruction processor, or a processing element such as a data processor, or such as a central processing unit (e.g., CPU1, CPU2, . . . , CPUN). According to certain embodiments of the disclosure, two or more instances of configuration 851 can be coupled by communications link 815 (e.g., backplane, LAN, PSTN, wired or wireless network, etc.) and each instance can perform respective portions of sequences of instructions as can be required to practice embodiments of the disclosure.

The shown computing platform 806 is interconnected to the Internet 848 through one or more network interface ports (e.g., network interface port 823₁ and network interface port 823₂). Configuration 851 can be addressed through one or more network interface ports using an IP address. Any operational element within computing platform 806 can perform sending and receiving operations using any of a range of network protocols, possibly including network protocols that send and receive packets (e.g., network protocol packet 821₁ and network protocol packet 821₂).

Computing platform 806 can transmit and receive messages that can be composed of configuration data and/or any other forms of data and/or instructions organized into a data structure (e.g., communications packets). In some cases, the data structure includes program instructions (e.g., application code) communicated through the Internet 848 and/or through any one or more instances of communications link 815. Received program instructions can be processed and/or executed by a CPU as it is received and/or program instructions can be stored in any volatile or non-volatile storage for later execution. Program instructions can be transmitted via an upload (e.g., an upload from an access device over the Internet 848 to computing platform 806). Further, program instructions and/or the results of executing program instructions can be delivered to a particular user via a download (e.g., a download from computing platform 806 over the Internet 848 to an access device).

Configuration 851 is merely one example configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets or can be configured as one VLAN. Multiple clusters can communicate between one module to another over a WAN (e.g., when geographically distal) or a LAN (e.g., when geographically proximal).

In some embodiments, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to management of block stores. Various implementations of the data repository comprise storage media organized to hold a series of records and/or data structures.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT”, issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT”, issued on Oct. 1, 2013, which is hereby incorporated by reference in its entirety.

FIG. 8B depicts a block diagram illustrating another virtualization system architecture 8B00 configured to implement one or more aspects of the present embodiments. As shown in FIG. 8B, virtualization system architecture 8B00 includes a collection of interconnected components, including an executable container instance 850 in a configuration 852. Configuration 852 includes a computing platform 806 that supports an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification (e.g., “http:”) and possibly handling port-specific functions. In some embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node can communicate directly with storage devices on the second node.

The operating system layer can perform port forwarding to any executable container (e.g., executable container instance 850). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and can include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “ls” or “ls -a”, etc.). The executable container might optionally include operating system components 878, however such a separate set of operating system components need not be provided. As an alternative, an executable container can include runnable instance 858, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 876. Such a container virtual disk controller can perform any of the functions that the aforementioned CVM virtual disk controller 826 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 8C is a block diagram illustrating virtualization system architecture 8C00 configured to implement one or more aspects of the present embodiments. As shown in FIG. 8C, virtualization system architecture 8C00 includes a collection of interconnected components, including a user executable container instance in configuration 853 that is further described as pertaining to user executable container instance 870. Configuration 853 includes a daemon layer (as shown) that performs certain functions of an operating system.

User executable container instance 870 comprises any number of user containerized functions (e.g., user containerized function1, user containerized function2, . . . , user containerized functionN). Such user containerized functions can execute autonomously or can be interfaced with or wrapped in a runnable object to create a runnable instance (e.g., runnable instance 858). In some cases, the shown operating system components 878 comprise portions of an operating system, which portions are interfaced with or included in the runnable instance and/or any user containerized functions. In some embodiments of a daemon-assisted containerized architecture, computing platform 806 might or might not host operating system components other than operating system components 878. More specifically, the shown daemon might or might not host operating system components other than operating system components 878 of user executable container instance 870.

In some embodiments, the virtualization system architecture 8A00, 8B00, and/or 8C00 can be used in any combination to implement a distributed platform that contains multiple servers and/or nodes that manage multiple tiers of storage where the tiers of storage might be formed using the shown data repository 831 and/or any forms of network accessible storage. As such, the multiple tiers of storage can include storage that is accessible over communications link 815. Such network accessible storage can include cloud storage or networked storage (e.g., a SAN or storage area network). Unlike prior approaches, the disclosed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In some embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

In some embodiments, any one or more of the aforementioned virtual disks can be structured from any one or more of the storage devices in the storage pool. In some embodiments, a virtual disk is a storage abstraction that is exposed by a controller virtual machine or container to be used by another virtual machine or container. In some embodiments, the virtual disk is exposed by operation of a storage protocol such as iSCSI or NFS or SMB. In some embodiments, a virtual disk is mountable. In some embodiments, a virtual disk is mounted as a virtual storage device.

In some embodiments, some or all of the servers or nodes run virtualization software. Such virtualization software might include a hypervisor (e.g., as shown in configuration 851) to manage the interactions between the underlying hardware and user virtual machines or containers that run client software.

Distinct from user virtual machines or user executable containers, a special controller virtual machine (e.g., as depicted by controller virtual machine instance 830) or as a special controller executable container is used to manage certain storage and I/O activities. Such a special controller virtual machine is sometimes referred to as a controller executable container, a service virtual machine (SVM), a service executable container, or a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors-thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 8D is a block diagram illustrating virtualization system architecture 8D00 configured to implement one or more aspects of the present embodiments. As shown in FIG. 8D, virtualization system architecture 8D00 includes a distributed virtualization system that includes multiple clusters (e.g., cluster 883₁, . . . , cluster 883_{N}) comprising multiple nodes that have multiple tiers of storage in a storage pool. Representative nodes (e.g., node 881₁₁, . . . , node 881_{1M}) and storage pool 890 associated with cluster 883₁ are shown. Each node can be associated with one server, multiple servers, or portions of a server. The nodes can be associated (e.g., logically and/or physically) with the clusters. As shown, the multiple tiers of storage include storage that is accessible through a network 896, such as a networked storage 886 (e.g., a storage area network or SAN, network attached storage or NAS, etc.). The multiple tiers of storage further include instances of local storage (e.g., local storage 891₁₁, . . . , local storage 891_{1M}). For example, the local storage can be within or directly attached to a server and/or appliance associated with the nodes. Such local storage can include solid state drives (SSD 893₁₁, . . . , SSD 893_{1M}), hard disk drives (HDD 894₁₁, . . . , HDD 894_{1M}), and/or other storage devices.

As shown, any of the nodes of the distributed virtualization system can implement one or more user virtualized entities (e.g., VE 888₁₁₁, . . . , VE 888_{11K}, . . . , VE 888_{1M1}, VE 888_{1MK}), such as virtual machines (VMs) and/or executable containers. The VMs can be characterized as software-based computing “machines” implemented in a container-based or hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 887₁₁, . . . , host operating system 887_{1M}), while the VMs run multiple applications on various respective guest operating systems. Such flexibility can be facilitated at least in part by a hypervisor (e.g., hypervisor 885₁₁, . . . , hypervisor 885_{1M}), which hypervisor is logically located between the various guest operating systems of the VMs and the host operating system of the physical infrastructure (e.g., node).

As an alternative, executable containers can be implemented at the nodes in an operating system-based virtualization environment or in a containerized virtualization environment. The executable containers are implemented at the nodes in an operating system virtualization environment or container virtualization environment. The executable containers can include groups of processes and/or resources (e.g., memory, CPU, disk, etc.) that are isolated from the node host computer and other containers. Such executable containers directly interface with the kernel of the host operating system (e.g., host operating system 887₁₁, . . . , host operating system 887_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 890 by the VMs and/or the executable containers.

Multiple instances of such virtualized controllers can coordinate within a cluster to form the distributed storage system 892 which can, among other operations, manage the storage pool 890. This architecture further facilitates efficient scaling in multiple dimensions (e.g., in a dimension of computing power, in a dimension of storage space, in a dimension of network bandwidth, etc.).

In some embodiments, a particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 881₁₁ can interface with a controller virtual machine (e.g., virtualized controller 882₁₁) through hypervisor 885₁₁ to access data of storage pool 890. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 892. For example, a hypervisor at one node in the distributed storage system 892 might correspond to software from a first vendor, and a hypervisor at another node in the distributed storage system 892 might correspond to a second software vendor. As another virtualized controller implementation example, executable containers can be used to implement a virtualized controller (e.g., virtualized controller 882_{1M}) in an operating system virtualization environment at a given node. In this case, for example, the virtualized entities at node 881_{1M} can access the storage pool 890 by interfacing with a controller container (e.g., virtualized controller 882_{1M}) through hypervisor 885_{1M} and/or the kernel of host operating system 887_{1M}.

In some embodiments, one or more instances of an agent can be implemented in the distributed storage system 892 to facilitate the herein disclosed techniques. Specifically, agent 884₁₁ can be implemented in the virtualized controller 882₁₁, and agent 884_{1M} can be implemented in the virtualized controller 882_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

### Exemplary Computer System

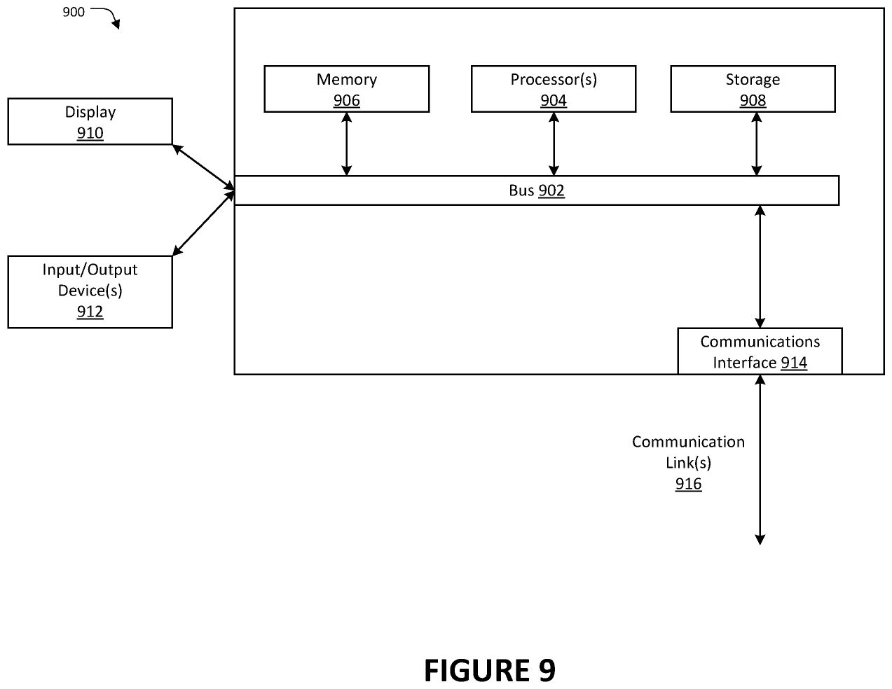

FIG. 9 is a block diagram illustrating a computer system 900 configured to implement one or more aspects of the present embodiments. In some embodiments, computer system 900 can be representative of a computer system for implementing one or more aspects of the embodiments disclosed in FIGS. 1-8D. In some embodiments, computer system 900 is a server machine operating in a data center or a cloud computing environment. suitable for implementing an embodiment of the present disclosure. As shown, computer system 900 includes a bus 902 or other communication mechanism for communicating information, which interconnects subsystems and devices, such as one or more processors 904, memory 906, storage 908, optional display 910, one or more input/output devices 912, and a communications interface 914. Computer system 900 described herein is illustrative and any other technically feasible configurations fall within the scope of the present disclosure.

The one or more processors 904 include any suitable processors implemented as a central processing unit (CPU), a graphics processing unit (GPU), an application-specific integrated circuit (ASIC), a field programmable gate array (FPGA), an artificial intelligence (AI) accelerator, any other type of processor, or a combination of different processors, such as a CPU configured to operate in conjunction with a GPU. In general, the one or more processors 904 can be any technically feasible hardware unit capable of processing data and/or executing software applications. Further, in the context of this disclosure, the computing elements shown in computer system 900 can correspond to a physical computing system (e.g., a system in a data center) or can be a virtual computing instance, such as any of the virtual machines described in FIGS. 8A-8D.

Memory 906 includes a random access memory (RAM) module, a flash memory unit, and/or any other type of memory unit or combination thereof. The one or more processors 904, and/or communications interface 914 are configured to read data from and write data to memory 906. Memory 906 includes various software programs that include one or more instructions that can be executed by the one or more processors 904 and application data associated with said software programs.

Storage 908 includes non-volatile storage for applications and data, and can include one or more fixed or removable disk drives, HDDs, SSD, NVMes, vDisks, flash memory devices, and/or other magnetic, optical, and/or solid state storage devices.

Communications interface 914 includes hardware and/or software for coupling computer system 900 to one or more communication links 915. The one or more communication links 915 can include any technically feasible type of communications network that allows data to be exchanged between computer system 900 and external entities or devices, such as a web server or another networked computing system. For example, the one or more communication links 915 can include one or more wide area networks (WANs), one or more local area networks (LANs), one or more wireless (WiFi) networks, the Internet, and/or the like.

In sum, an orchestrator module in an instance of a distributed computing system implements consistent indexes in distributed databases without using distributed transactions. When handling write or update requests received, in some embodiments, the orchestrator module causes a node in a given instance to store a primary key-value pair, which is stored in a primary table or column family, in a separate in-memory structure. The primary key-value pair is stored in the separate in-memory structure until secondary indexes are updated with secondary index key-value pairs based on the primary key-value pair. In some embodiments, the in-memory structure is a memtable in a shadow column family corresponding to the primary table. In other embodiments, the in-memory structure can be an external write-ahead log. Once stored in the separate in-memory structure, the orchestrator module performs various operations to read the primary key-value pairs stored in the in-memory structure, generate secondary index key-value pairs that correspond to the primary key-value pair, and transmit the generated secondary index key-value pairs to the secondary indexes. In some embodiments, the orchestrator module removes the primary key-value pair from the in-memory structure once the orchestrator module transmits the secondary index key-value pairs.

In alternative embodiments, the orchestrator module refers to a snapshot that identifies a sequence number corresponding to the last primary key-value pair in the primary table or column family that has corresponding updates at the secondary indexes. The orchestrator module obtains the sequence number from the snapshot and performs a delta scan by scanning through the primary table, starting with the obtained sequence number. For each primary key-value pair corresponding to sequence numbers identified through the delta scan, the orchestrator module generates secondary index key-value pairs and transmits the generated secondary index keys and values to the secondary index. Upon transmitting the generated secondary index key-value pairs to the respective secondary indexes, the orchestrator module generates a new snapshot that identifies a new sequence number corresponding to the last primary key-value that had corresponding updates sent to the secondary indexes.

Additionally or alternatively, when handling read or scan requests associated with one or more secondary index keys, the orchestrator module in a node containing a secondary index performs a query to the secondary index, as well as causes nodes in the distributed storage system to perform separate queries based on the secondary index key. The queries to the secondary index and at the other nodes include a sequential scan of the secondary index, and queries (e.g., scatter-gather listing operations) in other nodes. When performing queries in other nodes, the queries can focus on the in-memory structures where the primary key-value pairs are stored. Alternatively, the queries of the other nodes can include a delta scan of the primary table or column family storing the primary key-value pairs. When the queries of the other nodes identify primary key-value pairs matching the one or more secondary index keys, the orchestrator module merges the results accumulated from both the queries, where the merged results include a primary key-value pair and at least one secondary index key-value pair.

At least one technical advantage of the disclosed techniques relative to the prior art techniques is that the disclosed techniques enable secondary indexes in distributed storage systems to maintain consistency without relying on distributed transactions that are costly to implement over multiple across the distributed storage system. In particular, by using an orchestrator module to update secondary indexes in the background, and to provide results for secondary index-based queries, the distributed storage system is able to quickly acknowledge writes to the storage system while still maintaining consistency and correctness for queries based on the secondary index. Further, by storing the entries that have not been added to the secondary index in one or more in-memory tables, queries on the secondary index can maintain consistency and correctness without having to make time-consuming accesses to secondary storage. Additionally, by performing a delta scan of the primary index based on a snapshot taken after previous updates to the secondary index, the distributed database may quickly maintain consistency by focusing only on a subset of the primary index that has not yet been used to update the secondary index. These technical advantages provide one or more technological advancements over prior art approaches.

1. In various embodiments, one or more non-transitory computer-readable media store instructions that, when executed by one or more processors, causes the one or more processors to perform a method for supporting consistent secondary indexes comprising receiving, at a first node, a write request comprising a data entry, storing the data entry in an in-memory structure separate from a primary structure for storing the data entry, generating, based on the data entry, a secondary index data entry for a secondary index, and transmitting the secondary index data entry to a second node for inclusion in the secondary index.

2. The one or more non-transitory computer-readable media of clause 1, where the in-memory structure comprises a memtable.

3. The one or more non-transitory computer-readable media of clause 1 or 2, where the in-memory structure comprises an in-memory write-ahead log.

4. The one or more non-transitory computer-readable media of any of clause 1-3, where the method further comprises, after transmitting the secondary index data entry, removing the data entry from the in-memory structure.

5. The one or more non-transitory computer-readable media of any of clause 1-4, where generating the secondary index data entry is performed at the first node as a part of a background operation.

6. The one or more non-transitory computer-readable media of any of clause 1-5, where transmitting the secondary index data entry is performed at the first node as a part of a background operation.

7. The one or more non-transitory computer-readable media of any of clause 1-6, where the method further comprises generating, based on the data entry, a second secondary index data entry for a second secondary index, where a first key for the secondary index data entry is different than a second key for the second secondary index data entry, and transmitting the second secondary index data entry to a third node for inclusion in the second secondary index.

8. The one or more non-transitory computer-readable media of any of clause 1-7, where the method further comprises receiving, from the second node, a secondary index query, querying, based on the secondary index query, the in-memory structure to identify a first data entry matching the secondary index query that has not been updated to the secondary index, and generating a result that includes the first data entry.

9. The one or more non-transitory computer-readable media of any of clause 1-8, where the primary structure is not queried based on the secondary index query.

10. The one or more non-transitory computer-readable media of any of clause 1-9, where the data entry comprises a key-value pair.

11. In various embodiments, a computer-implemented method for supporting consistent secondary indexes comprises receiving, at a first node, a write request comprising a data entry, storing the data entry in an in-memory structure separate from a primary structure for storing the data entry, generating, based on the data entry, a secondary index data entry for a secondary index, and transmitting the secondary index data entry to a second node for inclusion in the secondary index.

12. The computer-implemented method of clause 11, where the in-memory structure comprises a memtable or a write-ahead log.

13. The computer-implemented method of clause 11 or 12, further comprising, after transmitting the secondary index data entry, removing the data entry from the in-memory structure.

14. The computer-implemented method of any of clauses 11-13, where generating the secondary index data entry and transmitting the secondary index data entry are performed at the first node as a part of a background operation.

15. The computer-implemented method of any of clauses 11-14, further comprising generating, based on the data entry, a second secondary index data entry for a second secondary index, where a first key for the secondary index data entry is different than a second key for the second secondary index data entry, and transmitting the second secondary index data entry to a third node for inclusion in the second secondary index.

16. The computer-implemented method of any of clauses 11-15, further comprising receiving, from the second node, a secondary index query, querying, based on the secondary index query, the in-memory structure to identify a first data entry matching the secondary index query that has not been updated to the secondary index, and generating a result that includes the first data entry.

17. The computer-implemented method of any of clauses 11-16, where the primary structure is not queried based on the secondary index query.

18. The computer-implemented method of any of clauses 11-17, where the data entry comprises a key-value pair.

19. In various embodiments, a system for supporting consistent secondary indexes comprises a memory storing instructions, and one or more processors that are coupled to the memory, which when executing the instructions is caused to receive, at a first node, a write request comprising a data entry, store the data entry in an in-memory structure separate from a primary structure for storing the data entry, generate, based on the data entry, a secondary index data entry for a secondary index, and transmit the secondary index data entry to a second node for inclusion in the secondary index.

20. The system of clause 19, where the in-memory structure comprises a memtable or a write-ahead log.

21. The system of clauses 19 or 20, where the one or more processors when executing the instructions is further caused to transmit the secondary index data entry, removing the data entry from the in-memory structure.

22. The system of any of clauses 19-21, where generating the secondary index data entry and transmitting the secondary index data entry are performed at the first node as a part of a background operation.

23. The system of any of clauses 19-22, where the one or more processors when executing the instructions is further caused to generate, based on the data entry, a second secondary index data entry for a second secondary index, where a first key for the secondary index data entry is different than a second key for the second secondary index data entry, and transmit the second secondary index data entry to a third node for inclusion in the second secondary index.

24. The system of any of clauses 19-23, where the one or more processors when executing the instructions is further caused to receive, from the second node, a secondary index query, query, based on the secondary index query, the in-memory structure to identify a first data entry matching the secondary index query that has not been updated to the secondary index, and generate a result that includes the first data entry.

25. The system of any of clauses 19-24, where the primary structure is not queried based on the secondary index query.

26. The system of any of clauses 19-25, where the data entry comprises a key-value pair.

27. In various embodiments, one or more non-transitory computer-readable media store instructions that, when executed by one or more processors, causes the one or more processors to perform a method for supporting consistent secondary indexes comprising receiving, at a first node, a write request comprising a data entry, storing the data entry in a storage structure, in response to determining that the data entry was written to the storage structure after a first snapshot was generated, generating a secondary index entry based on the data entry, and transmitting the secondary index entry to a second node for inclusion in the secondary index.

28. The one or more non-transitory computer-readable media of clause 27, where the first snapshot is associated with a first sequence number.

29. The one or more non-transitory computer-readable media of clause 27 or 28, where the method further comprises upon transmitting the secondary index entry, generating a second snapshot that includes a sequence number associated with the data entry.

30. The one or more non-transitory computer-readable media of any of clauses 27-29, where the method further comprises receiving, from the second node, a secondary index query, querying, based on the secondary index query, data entries stored after the first snapshot was generated to identify a first data entry matching the secondary index query that has not been updated to the secondary index, and generating a result that includes the first data entry.

31. The one or more non-transitory computer-readable media of any of clauses 27-30, where data entries stored before the first snapshot was taken are not queried based on the secondary index query.

32. The one or more non-transitory computer-readable media of any of clauses 27-31, where the data entry comprises a key-value pair.

33. In various embodiments, a computer-implemented method for supporting consistent secondary indexes comprises receiving, at a first node, a write request comprising a data entry, storing the data entry in a storage structure, in response to determining that the data entry was written to the storage structure after a first snapshot was generated, generating a secondary index entry based on the data entry, and transmitting the secondary index entry to a second node for inclusion in the secondary index.

34. The computer-implemented method of clause 33, where the first snapshot is associated with a first sequence number.

35. The computer-implemented method of clause 33 or 34, further comprising, upon transmitting the secondary index entry, generating a second snapshot that includes a sequence number associated with the data entry.

36. The computer-implemented method of any of clauses 33-35, further comprising receiving, from the second node, a secondary index query, querying, based on the secondary index query, data entries stored after the first snapshot was generated to identify a first data entry matching the secondary index query that has not been updated to the secondary index, and generating a result that includes the first data entry.

37. The computer-implemented method of any of clauses 33-36, where data entries stored before the first snapshot was taken are not queried based on the secondary index query.

38. The computer-implemented of any of clauses 33-37, where the data entry comprises a key-value pair.

39. In various embodiments, a system for supporting consistent secondary indexes comprises a memory storing instructions, and one or more processors that are coupled to the memory, which when executing the instructions is caused to receive, at a first node, a write request comprising a data entry, store the data entry in a storage structure, in response to determining that the data entry was written to the storage structure after a first snapshot was generated, generate a secondary index entry based on the data entry, and transmit the secondary index entry to a second node for inclusion in the secondary index.

40. The system of clause 39, where the first snapshot is associated with a first sequence number.

41. The system of clause 39 or 40, where the one or more processors when executing the instructions is further caused to, upon transmitting the secondary index entry, generate a second snapshot that includes a sequence number associated with the data entry.

42. The system of any of clauses 39-41, where the one or more processors when executing the instructions is further caused to receive, from the second node, a secondary index query, query, based on the secondary index query, data entries stored after the first snapshot was generated to identify a first data entry matching the secondary index query that has not been updated to the secondary index, and generate a result that includes the first data entry.

43. The system of any of clauses 39-42, where data entries stored before the first snapshot was taken are not queried based on the secondary index query.

44. The system of any of clauses 39-43, where the data entry comprises a key-value pair.

45. In various embodiments, one or more non-transitory computer-readable media store instructions that, when executed by one or more processors, causes the one or more processors to perform a method for supporting consistent secondary indexes, comprising receiving, by a first node, a read request comprising a secondary index key, querying, in the first node and based on the secondary index key, a secondary index associated with the secondary index key, transmitting, to at least a second node, a query to identify one or more data entries matching the secondary index key that have not been updated to the secondary index, merging one or more results obtained from the secondary index and the query transmitted to the first node to obtain a set of data entries associated with the read request, and returning the merged one or more results.

46. The one or more non-transitory computer-readable media of clause 45, where the second node searches, based on the query, an in-memory memtable or a write-ahead log.

47. The one or more non-transitory computer-readable media of clause 45 or 46, where the second node searches, based on the secondary index key, a subset of data entries that were written after a snapshot was generated.

48. The one or more non-transitory computer-readable media of any of clauses 45-47, further including instructions that, when executed by the one or more processors, cause the one or more processors to perform the step of transmitting, to at least a third node, the query to identify one or more data entries matching the secondary index key that have not been updated to the secondary index, where merging the one or more results further comprises merging results obtained from the query transmitted to the third node.

49. The one or more non-transitory computer-readable media of any of clauses 45-48, where the one or more data entries comprise one or more key-value pairs.

50. In various embodiments, a computer-implemented method for supporting consistent secondary indexes comprises receiving, by a first node, a read request comprising a secondary index key, querying, in the first node and based on the secondary index key, a secondary index associated with the secondary index key, transmitting, to at least a second node, a query to identify one or more data entries matching the secondary index key that have not been updated to the secondary index, merging one or more results obtained from the secondary index and the query transmitted to the first node to obtain a set of data entries associated with the read request, and returning the merged one or more results.

51. The computer-implemented method of clause 50, where the second node searches, based on the query, an in-memory memtable or a write-ahead log.

52. The computer-implemented method of clause 50 or 51, where the second node searches, based on the secondary index key, a subset of data entries that were written after a snapshot was generated.

53. The computer-implemented method of any of clauses 50-52, further comprising transmitting, to at least a third node, the query to identify one or more data entries matching the secondary index key that have not been updated to the secondary index, where merging the one or more results further comprises merging results obtained from the query transmitted to the third node.

54. The computer-implemented method of any of clauses 50-53, where the one or more data entries comprise one or more key-value pairs.

55. In various embodiments, a system for supporting consistent secondary indexes comprises a memory storing instructions, and one or more processors that are coupled to the memory and when executing the instructions performs a method comprising receiving, by a first node, a read request comprising a secondary index key, querying, in the first node and based on the secondary index key, a secondary index associated with the secondary index key, transmitting, to at least a second node, a query to identify one or more data entries matching the secondary index key that have not been updated to the secondary index, merging one or more results obtained from the secondary index and the query transmitted to the first node to obtain a set of data entries associated with the read request, and returning the merged one or more results.

56. The system of clause 55, where the second node searches, based on the query, an in-memory memtable or a write-ahead log.

57. The system of clause 55 or 56, where the second node searches, based on the secondary index key, a subset of data entries that were written after a snapshot was generated.

58. The system of any of clauses 55-57, further comprising transmitting, to at least a third node, the query to identify one or more data entries matching the secondary index key that have not been updated to the secondary index, where merging the one or more results further comprises merging results obtained from the query transmitted to the third node.

59. The system of any of clauses 55-58, where the one or more data entries comprise one or more key-value pairs.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RANI), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. One or more non-transitory computer-readable media storing instructions that, when executed by one or more processors, causes the one or more processors to perform a method for supporting consistent secondary indexes, the method comprising:
receiving, at a first node, a write request comprising a data entry;
storing the data entry in an in-memory structure separate from a primary structure for storing the data entry;
generating, based on the data entry, a secondary index data entry for a secondary index; and
transmitting the secondary index data entry to a second node for inclusion in the secondary index.

2. The one or more non-transitory computer-readable media of claim 1, wherein the in-memory structure comprises a memtable.

3. The one or more non-transitory computer-readable media of claim 1, wherein the in-memory structure comprises an in-memory write-ahead log.

4. The one or more non-transitory computer-readable media of claim 1, wherein the method further comprises, after transmitting the secondary index data entry, removing the data entry from the in-memory structure.

5. The one or more non-transitory computer-readable media of claim 1, wherein generating the secondary index data entry is performed at the first node as a part of a background operation.

6. The one or more non-transitory computer-readable media of claim 1, wherein transmitting the secondary index data entry is performed at the first node as a part of a background operation.

7. The one or more non-transitory computer-readable media of claim 1, wherein the method further comprises:
generating, based on the data entry, a second secondary index data entry for a second secondary index, wherein a first key for the secondary index data entry is different than a second key for the second secondary index data entry; and
transmitting the second secondary index data entry to a third node for inclusion in the second secondary index.

8. The one or more non-transitory computer-readable media of claim 1, wherein the method further comprises:
receiving, from the second node, a secondary index query;
querying, based on the secondary index query, the in-memory structure to identify a first data entry matching the secondary index query that has not been updated to the secondary index; and
generating a result that includes the first data entry.

9. The one or more non-transitory computer-readable media of claim 8, wherein the primary structure is not queried based on the secondary index query.

10. The one or more non-transitory computer-readable media of claim 1, wherein the data entry comprises a key-value pair.

11. A computer-implemented method for supporting consistent secondary indexes, comprising:
receiving, at a first node, a write request comprising a data entry;
storing the data entry in an in-memory structure separate from a primary structure for storing the data entry;
generating, based on the data entry, a secondary index data entry for a secondary index; and
transmitting the secondary index data entry to a second node for inclusion in the secondary index.

12. The computer-implemented method of claim 11, wherein the in-memory structure comprises a memtable or a write-ahead log.

13. The computer-implemented method of claim 11, further comprising, after transmitting the secondary index data entry, removing the data entry from the in-memory structure.

14. The computer-implemented method of claim 11, wherein generating the secondary index data entry and transmitting the secondary index data entry are performed at the first node as a part of a background operation.

15. The computer-implemented method of claim 11, further comprising:
generating, based on the data entry, a second secondary index data entry for a second secondary index, wherein a first key for the secondary index data entry is different than a second key for the second secondary index data entry; and
transmitting the second secondary index data entry to a third node for inclusion in the second secondary index.

16. The computer-implemented method of claim 11, further comprising:
receiving, from the second node, a secondary index query;
querying, based on the secondary index query, the in-memory structure to identify a first data entry matching the secondary index query that has not been updated to the secondary index; and
generating a result that includes the first data entry.

17. The computer-implemented method of claim 16, wherein the primary structure is not queried based on the secondary index query.

18. A system for supporting consistent secondary indexes, comprising:
a memory storing instructions; and
one or more processors that are coupled to the memory, which when executing the instructions is caused to:
receive, at a first node, a write request comprising a data entry;
store the data entry in an in-memory structure separate from a primary structure for storing the data entry;
generate, based on the data entry, a secondary index data entry for a secondary index; and
transmit the secondary index data entry to a second node for inclusion in the secondary index.

19. The system of claim 18, wherein the in-memory structure comprises a memtable or a write-ahead log.

20. The system of claim 18, wherein the one or more processors when executing the instructions is further caused to transmit the secondary index data entry, removing the data entry from the in-memory structure.

21. One or more non-transitory computer-readable media storing instructions that, when executed by one or more processors, causes the one or more processors to perform a method for supporting consistent secondary indexes, the method comprising:
receiving, by a first node, a read request comprising a secondary index key;
querying, in the first node and based on the secondary index key, a secondary index associated with the secondary index key;
transmitting, to at least a second node, a query to identify one or more data entries matching the secondary index key that have not been updated to the secondary index;
merging one or more results obtained from the secondary index and the query transmitted to the first node to obtain a set of data entries associated with the read request; and
returning the merged one or more results.

22. The one or more non-transitory computer-readable media of claim 21, wherein the second node searches, based on the query, an in-memory memtable or a write-ahead log.

23. The one or more non-transitory computer-readable media of claim 21, wherein the second node searches, based on the secondary index key, a subset of data entries that were written after a snapshot was generated.

24. The one or more non-transitory computer-readable media of claim 21, further including instructions that, when executed by the one or more processors, cause the one or more processors to perform the step of:
transmitting, to at least a third node, the query to identify one or more data entries matching the secondary index key that have not been updated to the secondary index;
wherein merging the one or more results further comprises merging results obtained from the query transmitted to the third node.

25. The one or more non-transitory computer-readable media of claim 21, wherein the one or more data entries comprise one or more key-value pairs.
